(19) United States
(12) Patent Application Publication
(10) Pub. No.: US 2024/0385465 A1
(43) Pub. Date: Nov. 21, 2024

(54) DISPLAY ELEMENT WITH AN IMAGE WHICH FLOATS ABOVE AND BELOW THE SUBSTRATE

(71) Applicant: GIESECKE+DEVRIENT CURRENCY TECHNOLOGY GMBH, Munchen (DE)

(72) Inventors: Thanh-Hao HUYNH, Bruckmuhl (DE); Christian FUHSE, Otterfing (DE)

(21) Appl. No.: 18/696,101

(22) PCT Filed: Sep. 22, 2022
(86) PCT No.: PCT/EP2022/025440

§ 371 Date: Mar. 27, 2024

(30) Foreign Application Priority Data
Sep. 29, 2021 (DE) 10 2021 004 910.1

(51) Int. Cl. G02B 30/56; G02B 5/10

(52) U.S. Cl. CPC G02B 30/56; G02B 5/10

(57) ABSTRACT

A display element having a substrate having a plurality of optical elements. The optical elements of a first grid consist of a first type of optical elements and the optical elements of a second grid consist of a second type of optical elements. The first type of optical elements is different from the second type of optical elements. In the event of tilting of the display element, the light spots 5 of the concave and convex mirror surfaces in this case move synchronously in opposing directions in the direction of the arrows, such that an observer 4 observes a particularly pronounced dynamic floating effect.

The invention relates to a display element having a substrate having an upper side and a lower side, wherein a plurality of optical elements is arranged in a surface region of the upper side.

By way of example, a generic display element is known from WO 2012/048847 A1. This display element generates a floating effect in which, when the display element is illuminated, a light spot image is generated from a plurality of light spots that appear, to an observer, to be floating above or below the surface region and that are arranged in the form of predetermined information or a motif. The optical elements are formed by refractive and/or reflective optical elements, wherein each light spot of the light spot image is associated with at least one refractive and/or reflective optical element that contributes, when the display element is illuminated, to generating the light spot associated therewith.

The disadvantage here is in particular that the floating effect is only slightly pronounced, since the plurality of light spots appears, to an observer, to be floating only at a small distance above or below the surface region, and has only a small contrast between the light spots floating above or below the surface region.

The invention is therefore based on the object of further developing a generic display element such that the disadvantages of the prior art are overcome.

This object is achieved by the features of the independent claim. Developments of the invention are the subject of the dependent claims.

According to the invention, one portion of the optical elements is arranged in a first grid and another portion of the optical elements is arranged in a second grid, wherein the first grid adjoins the second grid. The optical elements of the first grid consist of a first type of optical elements and the optical elements of the second grid consist of a second type of optical elements, wherein the first type of optical elements is different from the second type of optical elements. In this case, the optical elements of the first grid have a first focal plane that forms a first light spot grid, for example a foreground motif, and the optical elements of the second grid have a second focal plane that forms a second light spot grid, for example a background motif. The first light spot grid in this case has a different floating height or is at a different distance from the upper side of the substrate than the second light spot grid. Particularly preferably, the foreground motif in this case appears to float above the display element and the background motif appears to be located below the display element. Of course, the opposite variant may however also be selected here, in which the foreground motif appears to float below the display element and the background motif appears to be located above the display element. Furthermore, provision may also be made for a third or further grid consisting of a third or further different type of optical elements having third or further motifs at different floating heights and adjoining the first and/or second grid.

According to one particularly preferred embodiment, provision is made for the optical elements of the first grid to be at a first distance from the lower side of the substrate and for the optical elements of the second grid to be at a second distance from the lower side of the substrate, wherein the first distance is different from the second distance. Preferably, the first distance in this case differs from the second distance by up to around 200 m, particularly preferably by up to around 100 m and very particularly preferably by around 75 m. The optical elements of the first grid are thus arranged in a manner offset from the optical elements of the second grid in the direction of the lower side of the substrate. This has the particular advantage of improving optical contrast. In particular, the floating effect is enhanced since the distance between the floating height of the first light spot grid and the floating height of the second light spot grid is increased, and thus foreground motif and background motif are further apart from one another in the z-direction.

According to one preferred embodiment, provision is made for the first type of optical elements to be designed in a manner inverted or mirrored by around 170° to 190° and preferably by 180° about the transverse axis with respect to the second type of optical elements. The second type of optical elements in this case consists of the same optical elements as the first type of optical elements, for example of Fresnel lenses or Fresnel mirrors, with both types only being almost or completely inverted or mirrored by around 180° about the transverse axis. Thus, for the purposes of this invention, the fact that the first type of optical elements is different from the second type of optical elements also means that the first and second type of optical elements are the same type of optical elements, and these are inverted in relation to one another. The first type of optical elements may in this case for example be a convex structure consisting of optical elements and the second type of optical elements may be a concave structure of the same optical elements. A transverse axis is understood here to mean an axis that runs in the direction of the surface of the substrate, as opposed to the height axis, which is perpendicular to the surface of the substrate.

According to one preferred embodiment, provision is made for the lateral dimension of the first grid in the x-direction and/or y-direction to be at least three times, preferably at least five times, and particularly preferably at least ten times greater than the grid width of the light spot grid of the first grid or the distance between adjacent light spots or focal points of the optical elements of the first grid.

According to one preferred embodiment, provision is made for the optical elements to comprise curved mirrors, in particular concave mirrors or convex mirrors. The curved mirrors are in this case preferably spherical, elliptical, rotationally symmetric aspheric, non-rotationally symmetric aspheric or trough-shaped, with the troughs running linearly or curvilinearly in the latter case. Particularly preferably, the curved mirrors are formed at least partially by Fresnel mirrors.

The design of the curvature mirrors as Fresnel mirrors has the particular advantage that, in comparison to simple curvature mirrors, the embossing heights or embossing depths are able to be reduced. In addition to “true” Fresnel mirrors in which the individual segments are circular and are all designed with the same height, it is also possible for example to use micromirror arrangements as described in DE 10 2009 056 934 A1, in which individual facets may be arranged regularly or irregularly.

According to one preferred embodiment, provision is made for the optical elements to comprise lenses, in particular spherical, elliptical, rotationally symmetric aspheric, non-rotationally symmetric aspheric or cylindrical lenses. Particularly preferably, the lenses are formed at least partially by Fresnel lenses.

According to one preferred embodiment, provision is made for the optical elements of the first grid to be formed by curved mirrors and for the optical elements of the second grid to be formed by lenses.

According to one preferred embodiment, provision is made for the optical elements of the first grid to be formed by concave Fresnel mirrors and for the optical elements of the second grid to be formed by convex Fresnel mirrors and/or convex Fresnel lenses.

According to one preferred embodiment, provision is made for the optical elements to have essentially no optically diffractive effect.

According to one preferred embodiment, provision is made for the optical elements, in the lateral direction or in the xy-direction with respect to the upper side of the substrate, to have an extent of up to around 5 mm, preferably up to around 2 mm and particularly preferably of around 1 mm.

According to one preferred embodiment, provision is made for the optical elements, in the vertical direction or in the z-direction with respect to the upper side of the substrate, to have an extent of up to around 200 m, preferably up to around 100 m and particularly preferably of around 50 m.

In applications of the optical elements according to the invention to or in a substrate consisting of at least one plastic film or in a silver paint, varnish coating or metallization, the optical elements may also have much smaller extents in the lateral and/or vertical direction, and the difference between the first distance and the second distance may be much smaller. By way of example, the respective values for the extent or the distances may be less than or equal to 1 m. However, they must each be great enough that the optical elements essentially have no diffractive effect and so as to achieve a significantly increased contrast between the light spots floating above or below the surface region compared to the prior art.

In further embodiments, the light spots may also have no “real” floating height at all, but rather perform an orthoparallactic movement, that is to say for example run from east to west in the y-direction in the event of north-south tilting in the x-direction. For this purpose, the light spots may be generated for example with a “rotating mirror” known from DE 10 2009 056 934 A1 or a Fresnel lens with a “saddle-shaped phase function” known from WO 2011/110185 A1. In such embodiments as well, the light spots in the foreground and background region perform opposite movements in the event of tilting. For instance, the foreground may have light spots that run from east to west in the event of north-south tilting, while the light spots in the background run from west to east in the event of the same tilting movement. Although this then does not give a stereographic impression of depth, it does still give a striking effect of movement.

In principle, mixed forms consisting of parallactic and orthoparallactic movement are also possible, if for example a “rotating mirror” rotates the mirror image not by 90° but only by 45° in comparison to a normal curvature mirror.

According to one preferred embodiment, provision is made for a contour line to be arranged between the first and the second grid, which contour line is likewise curved or may exhibit a corresponding curvature effect on the basis of Fresnel structures.

According to one preferred embodiment, provision is made for the display element according to the invention to be produced solely based on films or, for example, also to be produced as a blind embossing (for example steel engraving) in a silver paint, a layer of varnish or metallization. The optical elements according to the invention may in this case be introduced directly into the upper side of the substrate or into the silver paint, layer of varnish or metallization that is applied to the upper side of the substrate.

The invention makes it possible to display objects with much clearer contour lines than is possible with the comparatively “highly pixelated” light spot images from WO 2012/048847 A1. It was surprisingly found here that the intrinsically fixed transition between the two regions does not noticeably interfere with the 3D effect or dynamics. The subject matter of the invention thus enables an optically appealing display of sharp-edged objects, which are more attractive and have a higher resolution, without loss of depth effect, than the light spot images from the prior art: In the prior art, “whole” Fresnel lenses (or at least always the same Fresnel lens sections) have usually been used to date, and resolution was limited by their size. This is because small-scale structures having a lateral dimension of one or two optical elements would be much more “highly pixelated” and would not look as attractive if the boundary between the two lens types were always to have to be at the edge between two “lens pixels”.

The substrate particularly preferably consists of at least one plastic film or of paper consisting of cotton fibers, as is used for example for banknotes, or of other natural fibers or of synthetic fibers or a mixture of natural and synthetic fibers. Again preferably, the substrate consists of a combination of at least two superimposed and interconnected different substrates, what is known as a hybrid. The substrate in this case consists for example of a combination of plastic film-paper-plastic film, that is to say a substrate made of paper is covered on each of its two sides with a plastic film, or of a combination of paper-plastic film-paper, that is to say a substrate made of a plastic film is covered on each of its two sides with paper.

Documents of value for which a display element according to the invention may be used are in particular banknotes, shares, bonds, certificates, vouchers, checks, high-quality admission tickets, but also other documents at risk of counterfeiting, such as passports and other identity documents, as well as cards, such as for example credit or debit cards, the card body of which has at least one layer of security paper, and also product security elements, such as labels, seals, packaging, folding boxes, leaflets and the like. The simplified name “document of value” includes all of the abovementioned materials, documents and product security means.

The terms “upper side” or “lower side” of the substrate are relative terms with respect to the observer of the display element, with an observer looking at the display element from the upper side of the substrate. In particular, these terms may also be referred to as “one side” and “the opposite side” and form the majority of the overall surface of the substrate. These terms expressly do not comprise the side surfaces of a substrate, which are vanishingly small in the case of a thickness of a substrate, which is only around a millimeter in the case of card bodies or only fractions of a millimeter in the case of banknotes, and which usually are not or cannot be provided with a display element.

The display element shows a motif that, for the purposes of this invention, is a pattern-shaped and visually perceptible display. By way of example, this may be an alphanumeric character string of numbers and/or letters, a graphic illustration, an image, a text or other characters. Particularly preferably, the motif consists here of positive and/or negative motifs. In the case of a positive motif, a motif element itself is in this case applied to the substrate, whereas, in the case of a negative motif, the region surrounding the motif element is applied to the substrate. A positive motif, for example, is a letter applied to the bright substrate in a dark color. A negative motif, for example, is a surface applied to the bright substrate in a dark color and having an unprinted region in the form of a letter within the surface.

It goes without saying that the abovementioned features and the features still to be explained below may be used not only in the specified combinations but also in other combinations without departing from the scope of the present invention, insofar as this is covered by the scope of the claims.

The advantages of the invention are explained with reference to the following exemplary embodiments and the supplementary figures. The exemplary embodiments constitute preferred embodiments to which the invention is in no way intended to be restricted, however. Furthermore, the embodiments described in the following exemplary embodiments are reduced to the essential key information for better intelligibility. Far more complex patterns or images may be used in the practical implementation.

In the figures, in detail:

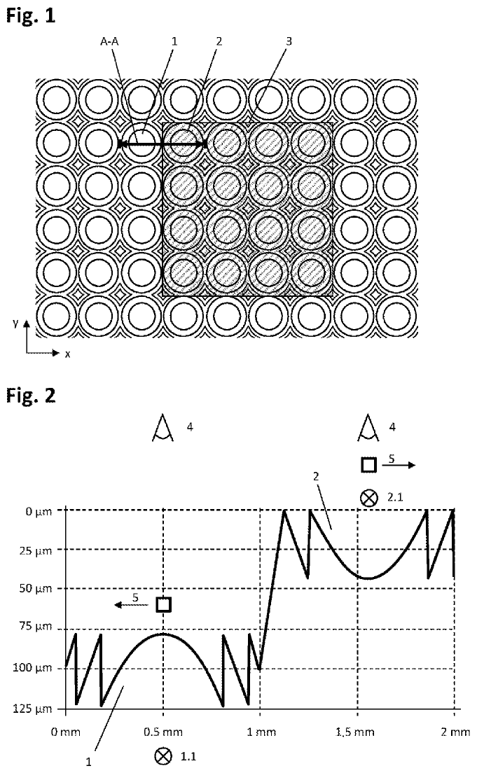

FIG. 1 shows a plan view of a display element according to the invention,

FIG. 2 shows a side view of a sectional image from FIG. 1 along the cutting surface A-A.

FIG. 1 shows a plan view of a display element, which is formed by a first array or first grid consisting of a plurality of curvature mirrors 2, each having the shape of a concave Fresnel mirror. The first grid is designed as an image motif 3 in the form of a square, which is illustrated by a hatching in FIG. 1 for better clarity. The surrounding surface of the image motif is formed by a second array or second grid consisting of a plurality of curvature mirrors 1 that are inverted or mirrored by 180° about the transverse axis with respect to the curvature mirrors 2 and thus each have the shape of a convex Fresnel mirror or a convex Fresnel lens.

The lateral dimension of the first grid, in the x-direction and in the y-direction, is in each case four times greater than the grid width of the light spot grid of the first grid or the distance between adjacent light spots or focal points of the optical elements of the first grid, or in other words than the diameter of a single curvature mirror 2.

FIG. 2 shows a side view of a sectional image from FIG. 1 along the cutting surface A-A. The curvature mirrors 2 are located on the upper side of the substrate and have a focal point 2.1. The curvature mirrors 1 have a focal point 1.1. The curvature mirrors 1 are offset downward in relation to the curvature mirrors 2 in the direction of the lower side of the substrate, wherein the distance between the curvature mirrors 2 and the lower side of the substrate is around 75 μm greater than the distance between the curvature mirrors 1 and the lower side of the substrate.

The selection of the concave and convex mirrors and the downward offset of the curvature mirrors 1 in the direction of the lower side of the substrate (or z-direction) in this case enable a maximum distance between the focal points 1.1 and 2.1. In the event of tilting of the display element, the light spots 5 of the concave and convex mirror surfaces in this case move synchronously in opposing directions in the direction of the arrows, such that an observer 4 observes a particularly pronounced dynamic floating effect.

1.-14. (canceled)

15. A display element having a substrate having an upper side and a lower side,
wherein a plurality of optical elements is arranged in a surface region of the upper side,
wherein one portion of the optical elements is arranged in a first grid and another portion of the optical elements is arranged in a second grid,
wherein the first grid adjoins the second grid,
wherein the optical elements of the first grid consist of a first type of optical elements and the optical elements of the second grid consist of a second type of optical elements,
wherein the first type of optical elements is different from the second type of optical elements.

16. The display element according to claim 15, wherein the optical elements of the first grid are at a first distance from the lower side of the substrate and the optical elements of the second grid are at a second distance from the lower side of the substrate,
wherein the first distance is different from the second distance.

17. The display element according to claim 15, wherein the first type of optical elements is designed in a manner inverted or mirrored by around 170° to 190° and 180° about a transverse axis with respect to the second type of optical elements.

18. The display element according to claim 15, wherein the optical elements comprise curved mirrors, concave mirrors or convex mirrors.

19. The display element according to claim 18, wherein the curved mirrors are spherical, elliptical, rotationally symmetric aspheric, non-rotationally symmetric aspheric or trough-shaped, with the troughs running linearly or curvilinearly in the latter case.

20. The display element according to claim 18, wherein the curved mirrors are formed at least partially by Fresnel mirrors.

21. The display element according to claim 15, wherein the optical elements comprise lenses, spherical, elliptical, rotationally symmetric aspheric, non-rotationally symmetric aspheric or cylindrical lenses.

22. The display element according to claim 21, wherein the lenses are formed at least partially by Fresnel lenses.

23. The display element according to claim 15, wherein the optical elements of the first grid are formed by curved mirrors and the optical elements of the second grid are formed by lenses.

24. The display element according to claim 15, wherein the optical elements of the first grid are formed by concave Fresnel mirrors and the optical elements of the second grid are formed by convex Fresnel mirrors and/or convex Fresnel lenses.

25. The display element according to claim 15, wherein the optical elements have no optically diffractive effect.

26. The display element according to claim 15, wherein the optical elements, in the lateral direction with respect to the upper side of the substrate, have an extent of up to around 5 mm.

27. The display element according to claim 15, wherein the optical elements, in the vertical direction with respect to the upper side of the substrate, have an extent of up to around 200 μm.

28. The display element according to claim 16, wherein the first distance differs from the second distance by up to around 200 μm.
